(19) United States
(12) Patent Application Publication
(10) Pub. No.: US 2007/0167075 A1
(43) Pub. Date: Jul. 19, 2007

(54) High-voltage electrical connector capable of being immersed in a fluid environment

(75) Inventor: Yves Cadoret, Le Mans (FR)

Correspondence Address: SUGHRUE MION, PLLC, 2100 PENNSYLVANIA AVENUE, N.W., SUITE 800, WASHINGTON, DC, 20037, US

(73) Assignee: CARRIER KHEOPS BAC, Le Mans (FR)

(21) Appl. No.: 11/643,803

(22) Filed: Dec. 22, 2006

(30) Foreign Application Priority Data
Dec. 26, 2005 (FR) 0513322

(51) Int. Cl. H01R 9/05

(52) U.S. Cl. 439/578

(57) ABSTRACT

The invention relates to a high-voltage electrical connector, characterized in that it comprises, on the one hand, at the connection of the contact part (5) and of the corresponding electrical conducting cable (65) of at least one of the connector parts (1, 3) and, on the other, at the take-up of the electromagnetic shielding element (81) of at least one of the connector parts (1, 3), at least one air-tight cavity that is electrically isolated and able to collect the air imprisoned in the electrical conducting cable (65).

The invention relates to a high-voltage electrical connector capable of being immersed in a fluid environment and, in particular, an electrical connector capable of being immersed in a marine environment and at great depths.

Such a connector may be subject to problems of electrical breakdown with the electrical high voltage that it carries, and to problems of electrical insulation of its shielding, notably due to the traces of air contained in the conducting cables. Indeed, the air contained within the conducting electrical cable connected to the connector can pose serious electrical problems if it is transferred as far as the contact part of one of the parts of the connector and similarly as far as the shielding take-up of this part.

In order to solve these problems, the connector according to the invention comprises, on the one hand, at the connection of the contact part and of the corresponding electrical conducting cable of at least one of the connector parts and, on the other, at the take-up of the electromagnetic shielding element (grounded) of at least one of the connector parts, at least one air-tight cavity that is electrically isolated and able to collect the air imprisoned in the electrical conducting cable.

This cavity may be formed by at least one conducting ring or sleeve assembled with air-tight seals between the said contact part and end sleeving of the electrical conducting connection cable, and similarly at the shielding take-up between the downstream part and the upstream part of the conducting cable, relative to the shielding take-up. This cavity has its internal wall at the same electrical potential both in the case of the connection of the contact part and of the end of the electrical conducting cable of one of the connector parts, and of the shielding take-up of one of the connector parts.

The result of this disposition is that any trace of air from the electrical conducting cable is imprisoned within a cavity at the same electrical potential, at the end of the conducting cable connected to the contact element of the corresponding connector part, or at the location of the shielding take-up of the corresponding connector part on the electrical conducting cable, this air thus no longer being able to be carried into the connector part with the risk of creating partial discharges inherent to electrical high voltage, and then of causing electrical breakdown of the connector and also of creating, relative to the shielding, interference-causing electric fields.

The invention is illustrated hereinbelow with the aid of an exemplary embodiment and with reference to the appended drawings, in which:

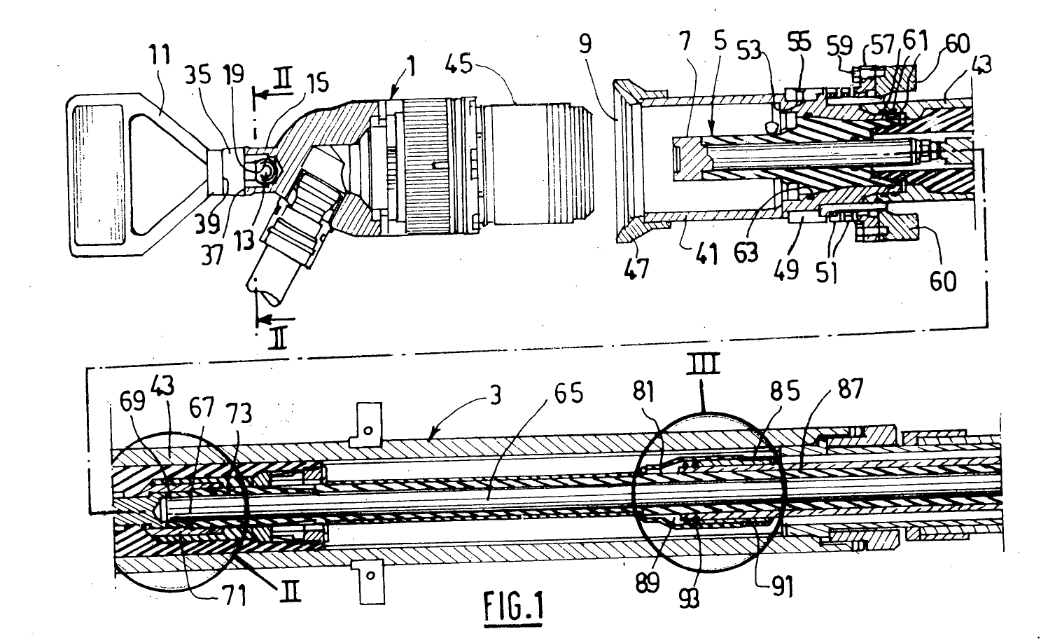

FIG. 1 is a partial axial cross-sectional view of an electrical connector according to the invention, in the disconnected position;

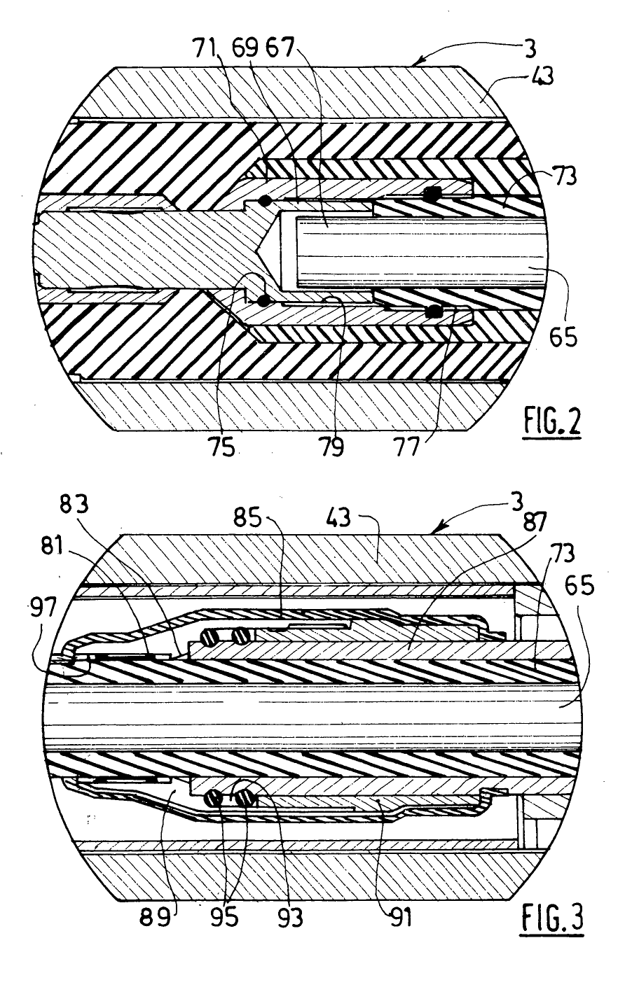

FIG. 2 is an enlarged axial cross-sectional view of the air-tight assembly of the end of the electrical conducting cable connected to the contact element of the receptacle, and

FIG. 3 is an enlarged axial cross-sectional view of the air-tight assembly of the shielding take-up of the conducting electrical cable on the connector receptacle.

The description will be presented with reference to an immersed electrical connector, simply by way of exemplary embodiment of the invention, the latter being applicable to other types of connector.

Reference will be made to the French patent application No. 03 14086 of 1 Dec. 2003 in the name of the applicant and which relates to an electrical connector connectable in water or in a liquid environment, the connector according to the present invention being of the type described in this patent application.

The connector according to the invention, such as is shown in FIG. 1, comprises a mobile connector part or plug 1 and a fixed connector part or receptacle 3. In the present case, the plug 1 is the female connector part and the receptacle 3 is the male connector part. This connector is of cylindrical form with axial symmetry and comprises a single contact 5 positioned in the axis of the connector, but it could comprise other identical contacts disposed in parallel within the cross section of the connector.

The receptacle 3 comprises a contact pin 7 of axial cylindrical form, disposed within the front part of the receptacle and slightly back from its opening 9.

When the connector is coupled together and the plug 1 is engaged into the receptacle 3, the pin 7 of the receptacle penetrates, in a sealed manner, into a complementary opening (not shown) of the front face of the plug, which face is closed in the unused position by a piston pushed forwards (not shown, reference may be made to the aforementioned patent application). It penetrates into a contact chamber (not shown), generally of the metal elastic socket type, where the contact is established when the connector is coupled together.

The isolation from air of the electrical conducting cable 65 at its connection end at a conductor part indicated by the highlight circle II of FIG. 1 is more particularly illustrated in FIG. 2.

The end 67 of the conducting cable 65 of the receptacle and similarly for the plug is received in a rear socket joint 69 that is complementary to the end of the contact element 5. The junction is made for example by tin soldering. A conducting ring 71, for example made of brass, of cylindrical form and of internal diameter equivalent to that of the sleeving of the connector cable, is installed at the junction 67 of the conducting cable 65 and of the contact element 5; it surrounds the contact socket joint 69 of the contact element 5 on its front part and the insulating sleeving 73 of the electrical cable 65 over a short length on its rear part. It is installed with air-tight seal onto the contact socket joint 69 using a flexible O-ring 75 inserted between these parts and similarly installed with air-tight seal onto the electrical conducting cable sleeving using a flexible O-ring 77 inserted between the sleeving 73 and the ring 71. Thanks to this disposition, the traces of air present in the conducting cable 65, inside the sleeving 73, are channelled up to the end 67 of the cable and remain trapped within the air-tight cavity 79 formed by the space existing between the two sealing O-rings 75, 77, the ring alignment opening, the external wall of the socket joint 69 and the external wall of the sleeving 73. This air cannot get into the connector part and therefore has no effect on the connector.

The isolation from air at the grounded shielding take-up 81 of the conducting cable 65 inside the receptacle 3 (and similarly for the plug 1) is illustrated in FIG. 3, corresponding to the highlight circle III in FIG. 1.

This shielding take-up 81 of the conducting cable 65 corresponds to a baring of the shielding braid 83, which is connected to a conventional braiding grounding lug (not shown). This shielding take-up 81 is surrounded by a conducting sleeve field expander 85, which surrounds with a air-tight grip the insulating sleeving 73 of the conducting cable 65 upstream of the shielding take-up 81, and similarly surrounds the conducting cable 65 downstream on its second coaxial sleeving 87 (protecting the shielding braid 83). This field expander sleeve 85 encloses two conducting rings assembled together, one front ring 89 surrounding the shielding take-up 81 and one rear ring 91 applied onto the second coaxial sleeving 87 and connecting the braiding 83 to the grounding lug. An internal annular interval 93 is provided in between the two rings 89, 91, which receives at least one flexible annular seal and for example two flexible annular air-tight seals 95, inserted between the front ring 89 and the second insulating sleeving 87. Under these conditions, any trace of air present in the cable 65 at the shielding take-up 81 is trapped in the free space or cavity 97 existing between the front end of the field expander sleeve 85 and the air-tight seals 95, and bounded by the internal opening of the front ring 89 and the external wall of the first insulating sleeving 73. This air thus imprisoned cannot circulate inside the connector so as to create electromagnetic interference.

The invention thus provides an immersed high-voltage electrical connector with high electrical reliability.

1. High-voltage electrical connector, characterized in that it comprises, on the one hand, at the connection of the contact part (5) and of the corresponding electrical conducting cable (65) of at least one of the connector parts (1, 3) and, on the other, at the take-up of the electromagnetic shielding element (81) of at least one of the connector parts (1, 3), at least one air-tight cavity (79, 97) that is electrically isolated and able to collect the air imprisoned in the electrical conducting cable (65), the said cavity (79) being formed by at least one conducting ring or sleeve (71) assembled with air-tight seals (75, 77) between the said contact part (5) and end sleeving (73) of the electrical conducting cable (65).

2. Connector according to claim 1, in which the said air-tight cavity (79, 97) has its internal wall at the same electrical potential.

3. Connector according to either of claims 1 and 2, in which the space (97) is bounded by the elements (85, 89, 91, 95) at the location of the shielding take-up (81) between the downstream part and the upstream part, relative to the shielding take-up (81), of the conducting cable (65).

4. Electrical connector according to claim 3, characterized in that the said shielding take-up (81) uncovering the shielding braid (83) of the conducting cable (65) is surrounded by a conducting sleeve field expander (85), which surrounds with an air-tight grip the insulating sleeving (73) of the conducting cable (65) upstream of the shielding take-up (81), and similarly surrounds the conducting cable (65) on its second coaxial sleeving (87) protecting a shielding braid (83), this field expander sleeve (85) enclosing at least two conducting rings assembled with one front ring (89) surrounding the shielding take-up (81) and one rear ring (91) being applied onto the second coaxial sleeving (87) and connecting the shielding braid (83) to a grounding lug, at least one flexible annular air-tight seal (95) being inserted between the front ring (89) and the second outside sleeving (87).
